(19) United States
(12) Patent Application Publication
(10) Pub. No.: US 2004/0154626 A1
(43) Pub. Date: Aug. 12, 2004

(54) Mouthguard

(75) Inventors: Steve J. Washburn, Shorewood, MN (US); Jon Wong, Long Beach, CA (US)

Correspondence Address: SCHWEGMAN, LUNDBERG, WOESSNER & KLUTH, P.A., P.O. BOX 2938, MINNEAPOLIS, MN, 55402, US

(73) Assignee: E-Z Gard Industries, Inc.

(21) Appl. No.: 10/366,285

(22) Filed: Feb. 12, 2003

(51) Int. Cl. A61C 5/14

(52) U.S. Cl. 128/861

(57) ABSTRACT

A mouthguard that includes a U-shaped base with an anterior portion situated between posterior portions. The U-shaped base is made of a first softenable material and includes a top side and a bottom side. The mouthguard further includes an outer wall that extends up from the top side of the base. Each of the posterior portions includes an end portion that is made of a second material that is harder than the first material. Another mouthguard includes a U-shaped base with an anterior portion between posterior portions. The U-shaped base is made from a first material and includes a top side, a bottom side and an outer wall that extends up from the top side of the U-shaped base. The mouthguard further includes a pair of pads such that each of the pads extend posteriorly out from a unique one of the posterior portions on the U-shaped base.

### FIELD OF THE INVENTION

The present invention relates generally to protective mouthguards for use by athletes, and more particularly to a mouthguard that absorbs, attenuates and dissipates shock forces exerted on the mouthguard.

### BACKGROUND OF THE INVENTION

Headaches, earaches, ringing in the ears, clogged ears, vertigo, concussions and dizziness are just some of the symptoms that can result when an athlete is subjected to impacts, collisions or blows to the jaw structure during athletic activity. These physical problems may be exacerbated when the athlete fails to use a mouthguard, or uses an improperly fitted mouthguard.

A number of mouthguards currently exist for protecting teeth from injuries as a result of high impact collisions during athletic competition. Some mouthguards are custom-formed to work with a particular individual.

Many mouthguards also include a tether that can be used to connect the mouthguard to an object, such as a helmet or face guard, that is near the user's mouth. Attaching the tether to an object near the user's mouth helps to prevent the mouthguard from being lost.

Mouthguards are typically made from ethylene vinyl acetate (EVA) which has a softening point that is less than the temperature of boiling water. A custom mouthguard that is made from EVA is fabricated by placing the mouthguard in sufficiently hot water until the mouthguard becomes soft. Once the mouthguard softens, it is removed from the water and then placed into an individual's mouth. The individual compresses his/her teeth against the softened mouthguard such that the mouthguard becomes custom fit to the individual's mouth. The mouthguard assumes the customized shape as the mouthguard hardens upon cooling.

One drawback with mouthguards made exclusively from EVA is that they do not sufficiently absorb, attenuate and dissipate the shock forces that are exerted on a mouthguard during athletic activity. Furthermore, EVA mouthguards typically lack durability and are vulnerable to damage from chewing by a wearer.

There is a need for a durable and customizable mouthguard that absorbs, attenuates and dissipates shock forces exerted on the mouthguard during athletic activity. The mouthguard should also be durable enough to stand up to the wear and tear that is generated by a user who habitually chews their mouthguard.

### SUMMARY OF THE INVENTION

A mouthguard that includes a U-shaped base with an anterior portion situated between posterior portions. The U-shaped base is made of a first softenable material and includes a top side and a bottom side. The mouthguard further includes an outer wall that extends up from the top side of the base. Each of the posterior portions on the U-shaped base includes an end portion that is made of a second material that is harder than the first material to minimize damage which can result when a user chews the mouthguard.

In another embodiment, a mouthguard includes a U-shaped base with an anterior portion between posterior portions. The base is made from a first material and includes a top side, a bottom side and an outer wall that extends up from the top side of the base. The base includes a pair of pads such that each of the pads extend posteriorly out from a unique one of the posterior portions on the U-shaped. The pads minimize damage associated with chewing the mouthguard. In some embodiments, the pads may be removable and/or made from a second material that is harder than the first material.

In still another embodiment, a mouthguard includes a U-shaped base and outer wall that are made of a first material and a honeycomb frame that is made of a second material. The U-shaped base includes a top side and a bottom side such that the outer wall extends up from the top side of the base. The honeycomb frame is secured to at least one of the U-shaped base and the outer wall. The honeycomb frame at least partially absorbs impact forces on the mouthguard by distributing energy throughout the honeycomb frame when the mouthguard is subjected to impact forces.

In other embodiments, a mouthguard includes a U-shaped base having a top side, a bottom side and an outer wall that extends from the top side of the U-shaped base. A handling tab is attached to at least one of the U-shaped base and the outer wall. The handling tab may be torn away from the mouthguard after boiling and forming operations associated with customizing the mouthguard.

In another embodiment, a mouthguard includes a frame made of a second material. The mouthguard further includes a U-shaped base that extends through at least one opening in the frame. The U-shaped base includes a top side and a bottom side, and is formed from a first material that softens at a lower temperature than the second material to allow imprints of upper and lower teeth to be made in the upper and/or lower sides of the U-shaped base when the mouthguard is customized.

In yet another embodiment, a mouthguard includes a U-shaped base with a top side and an outer wall that extends from the top side of the U-shaped base. The mouthguard further includes a frame is mounted on an outside surface of the outer wall. A compression column is embedded within the frame to disperse energy throughout the frame.

In still another embodiment, a mouthguard includes a U-shaped base with a top side and an outer wall extending from the top side of the U-shaped base. The U-shaped base and outer wall are made from the first material. The mouthguard further includes a frame that is made of a second material and is secured to the outer wall. The frame includes an upper portion, a lower portion and a V-shaped support extending between the upper portion and the lower portion of the frame to dissipate impact forces exerted upon the mouthguard.

In yet another embodiment, a mouthguard includes a U-shaped base made from a first material. The U-shaped base includes a top side and a bottom side such that a plurality of dimples, which are made from the first material, are formed on the top side of the U-shaped base. The dimples promote customizing the top side of the U-shaped base without material overflow during a fitting operation. Eliminating or reducing material overflow during forming creates a better fitting mouthguard.

In still another embodiment, a mouthguard includes a U-shaped base having a top side and an outer wall that extends up from the top side of the U-shaped base. The U-shaped base and the outer wall are made from a first material. The mouthguard further includes a U-shaped frame that supports the U-shaped base. The U-shaped frame is made of a second material that has a higher softening temperature than the first material and includes an interior side and an exterior side. The U-shaped frame includes at least one groove in the interior side of the U-shaped frame which allows the U-shaped frame to more easily flex during forming so that the mouthguard is more easily customized to fit a particular user.

In still another embodiment, a method of customizing a mouthguard includes placing a U-shaped base that is made of a first material and includes a top side and a bottom side in a liquid bath of sufficient temperature to soften the U-shaped base; and forming the U-shaped base by engaging teeth with the top side of the base and a plurality of dimples that are made from the first material and formed on the top side of the base to customize the mouthguard without material overflow.

In another embodiment, a method of customizing a mouthguard includes placing a U-shaped base that has pads extending posteriorly out from posterior portions on the U-shaped base in a bath of sufficient temperature to soften the U-shaped base; forming the U-shaped base by engaging teeth with the U-shaped base; and removing the pads to customize the mouthguard.

Other features will become obvious with a reading of the following specification and appended claims as well as a review of the figures.

### BRIEF DESCRIPTION OF THE DRAWINGS

FIG. 1A is a maxillary mandibular buccal or partial side elevation view of the jaws and temporomandibular joint of a user of a mouthguard of the present invention.

FIG. 1B is an enlarged view of the circle temporomandibular joint portion of FIG. 1A.

FIG. 2 is a perspective view of a mouthguard that includes a honeycomb frame shown in phantom.

FIG. 3 is top view illustrating the mouthguard of FIG. 2.

FIG. 4 is a section view along the lines 4-4 of FIG. 3.

FIG. 5 is a section view similar to FIG. 4 illustrating another embodiment of the mouthguard shown in FIG. 3.

FIG. 6 is a section view similar to FIG. 4 illustrating another embodiment of the mouthguard shown in FIG. 3.

FIG. 7 is a perspective view of another mouthguard.

FIG. 8 is a perspective view of another mouthguard.

FIG. 9 is a top view of another mouthguard.

FIG. 10 is a bottom view of the mouthguard shown in FIG. 9.

FIG. 11 is a top view of another mouthguard that includes a frame.

FIG. 12 is a block diagram illustrating a method of customizing a mouthguard.

FIG. 13 is a block diagram illustrating another method of customizing a mouthguard.

### DETAILED DESCRIPTION

In the following detailed description, reference is made to the accompanying drawings which show by way of illustration specific embodiments in which the invention may be practiced. These embodiments are described in sufficient detail to enable those skilled in the art to practice the invention. It is to be understood that other embodiments may be utilized and that structural changes made such that the following detailed description is not to be taken in a limiting sense.

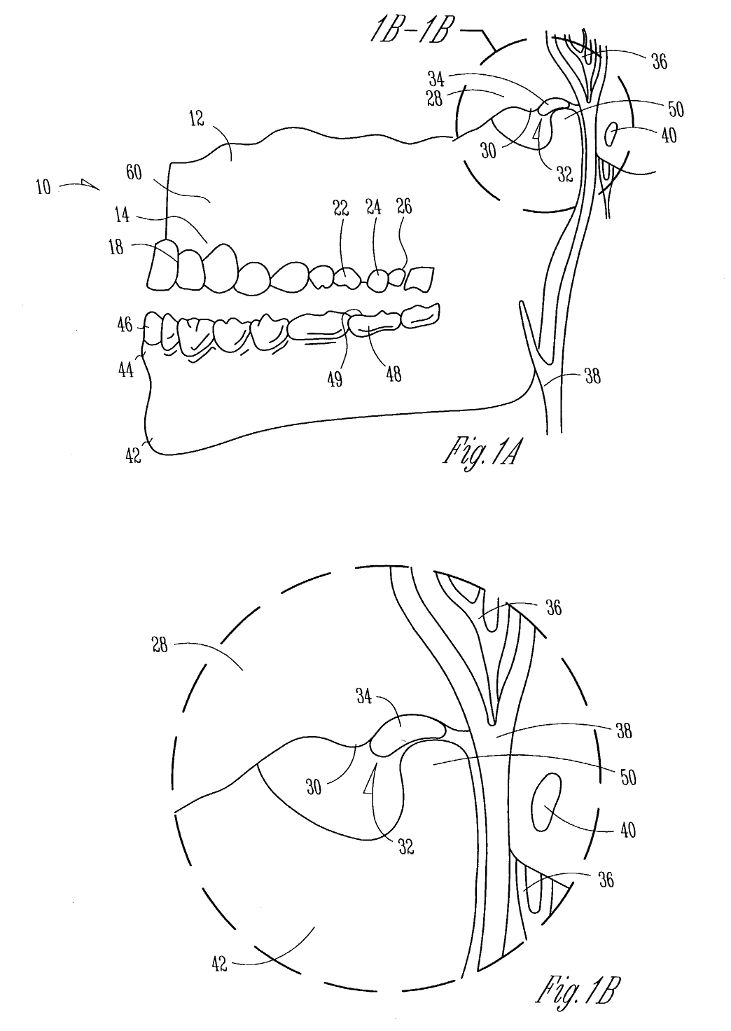

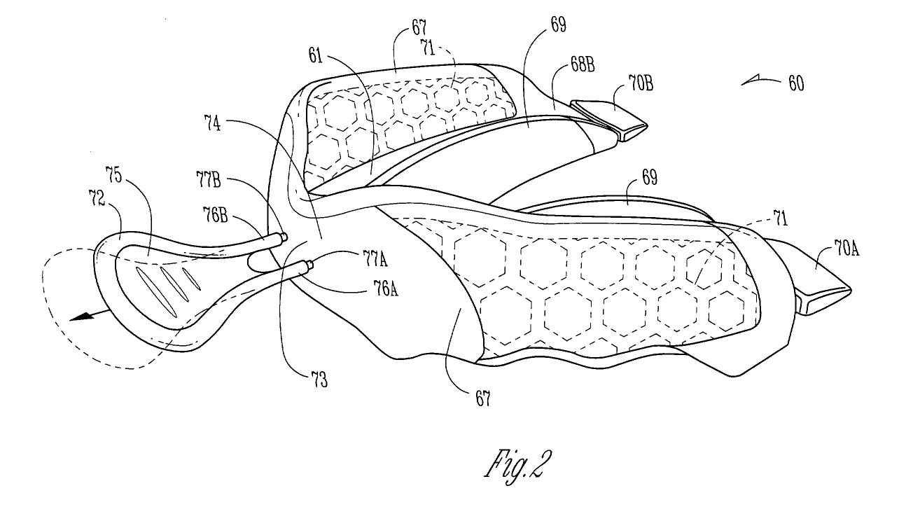

FIGS. 1A and 1B illustrate some of the human anatomy that is associated with a user of a mouthguard. A mouthguard user would have a mouth 10 that is generally comprised of a rigid upper jaw 12 and a movable lower jaw 42 which are movably connected at the temporomandibular joint (TMJ) 32 and 50.

The rigid upper jaw 12 has gum tissue 14 within mouth 10. Gum tissue 14, as well as the bone thereunder, support anterior teeth (incisors and canines) 18 which have incisal or biting surfaces. The gum tissues 14 and the bone thereunder also support posterior teeth (molars and bicuspids) 22 which have cusps and biting surfaces 26.

Referring to one side of the human head, the temporal bone 28 is located upwardly and rearwardly of the upper jaw 12. The articular eminence 30 forms the beginning of the fossa 32, or socket, of the temporomandibular joint 32 and 50. Rearwardly and posteriorly to the articular eminence 30 is located cartilage 34. Through the temporomandibular joint 32 and 50 pass the auriculotemporalis nerve 36 and the supra-temporal artery.

The movable jaw or mandible 42 supports a bone covered by gum tissue 44 which further supports anterior teeth (incisors and canines) 46 and posterior teeth (molars and bicuspids) 48 with occlusal surfaces 52. The condyle 50 of the lower jaw 42 forms the ball of the temporomandibular joint 32 and 50. This anatomical structure is the same for both sides of the head.

Repeated impacts, collisions, blows or forces exerted on the movable lower jaw 42 result in excessive wearing forces upon the condyle 50 and the cartilage or disc 34 that may result in deterioration or slippage of the cartilage 34. Thereafter, the lower jaw 42 may be subject to irregular movement, loss of comfortable range of movement and clicking of the joint 32 and 50.

The auriculo-temporalis nerve 36 relates to both sensory and motor activities of the body. Any impingement or pinching of this nerve 36 can result in health problems as previously mentioned. The supra-temporal artery 38 is important in that it provides blood circulation to the head. Impingement, pinching, rupture or blockage of this artery 38 will result in possible loss of consciousness and reduced physical ability and endurance due to the restriction of blood flow to the brain. Thus, it is extremely important to assure that the condyle 50 does not impinge upon the auriculo-temporalis nerve 36 or the supra-temporal artery 38.

It is also important to note that the temporal bone 28 is not too thick. Medical science has known that a sharp shock or concussive force applied to the lower jaw 42 possibly could result in the condyle 50 protruding through the temporal bone 28 thereby causing death.

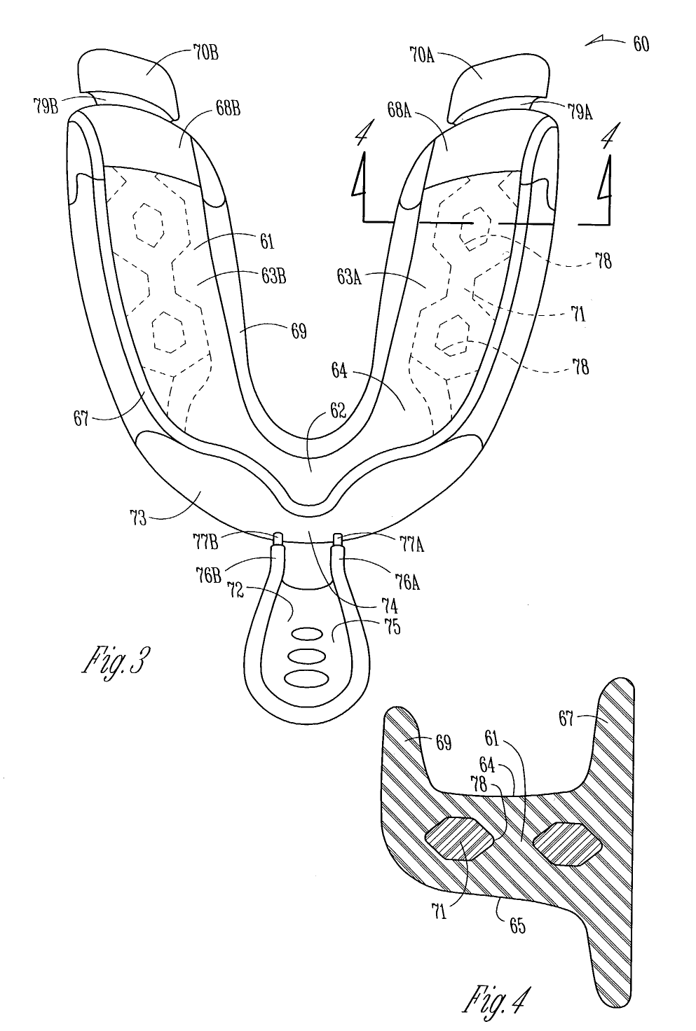

FIGS. 2-4 illustrate a mouthguard 60. Mouthguard 60 includes a U-shaped base 61 with an anterior portion 62 situated between posterior portions 63A, 63B (see FIG. 3). The U-shaped base 61 includes a top side 64 and a bottom side 65 (see FIG. 4), and is made of a first softenable material. The top side 64 of the U-shaped base 62 receives teeth on the upper jaw.

The outer wall 67 may have a uniform thickness to reduce sagging that might occur during the fitting process. The mouthguard 60 further includes an outer wall 67 extending up from the top side 64 of the U-shaped base 61. Each of the posterior portions 63A, 63B includes an end portion 68A, 68B that is made of a second (e.g., nonsoftenable) material which is harder than the first material to minimize damage which can result when a user chews the mouthguard 60. The end portions 68A, 68B may form at least one-quarter of the posterior portions 63A, 63B.

In some embodiments, the U-shaped base 61 is made of a first softenable thermoplastic, such as copolymers of ethylene and vinyl acetate. One example copolymer is ethylene vinyl acetate (EVA) which is commercially available and approved for oral use by the Food and Drug Administration. In one example embodiment, the first thermoplastic is a copolymer having vinyl acetate in the range of 18% to 28% by weight. A commercial copolymer suitable for use is Elvax® resin marketed by the GP Division of Ashland Chemical Co. Elvax® Resin 250 through 450 has the desired proportions of vinyl acetate. Most preferably, Elvax® 250 should be used, which has 25% by weight of vinyl acetate.

The second material that forms the end portions 68A, 68B may be a non-softening, resilient, low compression elastomer, which unlike copolymers of ethylene and vinyl acetate, exhibits a high resilience, low compression, shape maintenance and shock absorption, attenuation and dissipation. Virtually all rubbers that exhibit these physical characteristics may be utilized for the end portions 68A, 68B, including vulcanized rubber.

In another example embodiment, the second material is a composite of a copolymer of ethylene and vinyl acetate, such as the Elvax® resins discussed above, and an elastomeric material selected from the group consisting of thermoplastic rubber and vulcanized rubber. One example is a thermoplastic rubber marketed under the trademark KRATON®, which is marketed by GLS Plastics of 740B Industrial Drive, Cary, Ill. 60013. This thermoplastic rubber is unique in that it is injection moldable, FDA approved and readily adheres with copolymers of ethylene and vinyl acetate. Furthermore, the thermoplastic rubber has a melting or softening point significantly higher than that of EVA. Consequently, the end portions 68A, 68B may be molded before the U-shaped base 61 and any side walls of the mouthguard 60.

In a sample embodiment, the second material is comprised of 50% to 80% by weight of the elastomeric material and 20% to 50% by weight of the copolymer of ethylene and vinyl acetate. The copolymer may comprise vinyl acetate in the range of 18% to 28% by weight, and most preferably 25% by weight.

In some embodiments, mouthguard 60 may include an inner wall 69 that extends up from the top side 64 of the U-shaped base 61 to form an upper channel with the top side 64 of the U-shaped base 61 and the outer wall 67. As shown in FIGS. 2-3, the inner wall 69 and the outer wall 67 may also include posterior portions that are integrally formed with the posterior portions 63A, 63B of U-shaped base 61. The posterior portions of the inner wall 69 and the out wall 67 may also include end portions that are integral with the end portions 68A, 68B of the U-shaped base 61 such that the end portions of the inner and outer walls 67, 69 are also made from the second material. The end portions 68A, 68B of the U-shaped base 61 may be sized with a thickness that assures proper fitting of the composite mouthguard 60 during forming by prohibiting the user from biting too deeply in the soft EVA material of the U-shaped base 61.

In the example embodiment illustrated in FIGS. 2 and 3, a pair of pads 70A, 70B also extend posteriorly out from the end portions 68A, 68B of the U-shaped base 61 to minimize damage associated with chewing the mouthguard. It should be noted that in some embodiments which include pads 70A, 70B, the posterior portions 63A, 63B (including the end portions 68A, 68B) of the U-shaped base 61 may be made entirely from the first material.

Each of the pads 70A, 70B may be removable such that the mouthguard 60 can be customized by separating the removable pads 70A, 70B from the U-shaped base 61. In some embodiments, each of the removable pads 70A, 70B engages the U-shaped base 61 at shearing areas 79A, 79B that have reduced cross-sections compared to the pads 70A, 70B. The pads 70A, 70B may be sized to be thinner than the U-shaped base 61 but with enough thickness to prohibit an individual from biting too deeply into the U-shaped base 61 during a forming operation.

In some example embodiments, mouthguard 60 includes a honeycomb frame 71 that is made of the second material. The honeycomb frame 71 is secured to at least one of the U-shaped base 61, outer wall 67 and inner wall 69. The honeycomb frame 71 at least partially absorbs impact forces generated on the mouthguard 61 by distributing energy throughout the honeycomb frame 71.

In some embodiments, the honeycomb frame 71 is embedded within at least a portion of the mouthguard 60, while in other embodiments, the honeycomb frame 71 is embedded entirely within the mouthguard 60. The honeycomb frame 71 may be embedded within one of the U-shaped base 61, the inner wall 69 and the outer wall 67; or any two of the U-shaped base 61, the inner wall 69 and the outer wall 67. The honeycomb frame 71 may also be embedded within at least a portion of each of the U-shaped base 61, the inner wall 69 and the outer wall 67.

The honeycomb frame 71 may include a pattern of openings, such as hexagonal openings. It should be noted that the openings in the pattern of openings may all be the same size or select different sizes.

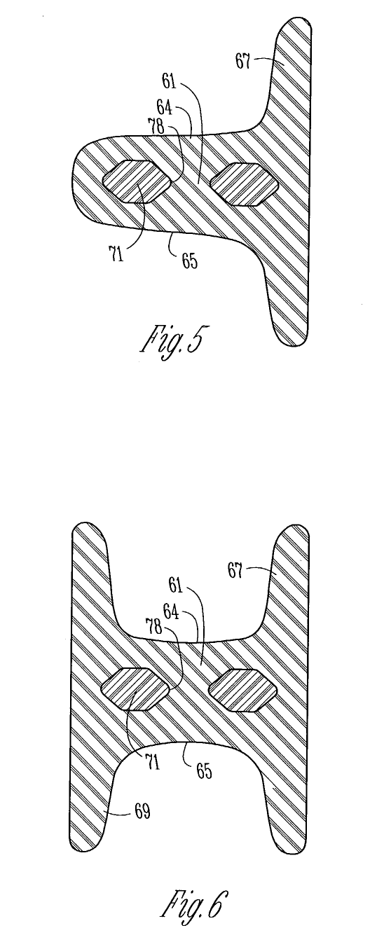

In the example embodiments illustrated in FIGS. 4-6, outer wall 67 extends from the top side 64 and the bottom side 65 of the U-shaped base 61 to protect the upper and lower teeth of someone that uses mouthguard 60. The outer wall 67 may extend from the top and bottom sides 64, 65 of the U-shaped base 61 over just a portion of the U-shaped base 61 (such as some, or all, of posterior portions 63A, 63B on U-shaped base 61). In addition, the inner wall 69 may extend from the top and/or bottom sides 64, 65 of the U-shaped base 61 (see, e.g., FIGS. 5 and 6). The inner wall 69 may extend from all of the U-shaped base 61, or just a portion of the U-shaped base 61 (such as some, or all, of the posterior portions 63A, 63B on U-shaped base 61).

Mouthguard 60 may also include a handling tab 72 that is attached to at least one of the U-shaped base 61 or outer wall 67 to provide a safe area to handle the mouthguard 60 during boiling and forming operations associated with the customizing the mouthguard 60. In one sample embodiment, the handling tab 72 is attached to an outside surface 73 on an anterior section 74 of the outer wall 67. The illustrated example handling tab 72 includes a body 75 and a pair of extensions 76A, 76B projecting from the body 75. The extensions 76A, 76B engage the U-shaped base 61 or outer wall 67 to provide tearing, or shearing, areas 77A, 77B for separating the removable tab 72 from the mouthguard 60. It should be noted that the extensions 76A, 76B may engage any portion of the outer wall 67, U-shaped base 61 and/or inner wall 69 at one or more locations.

In some embodiments, frame 71 includes at least one opening, such as openings 78, that are located in U-shaped base 61 (see FIGS. 3-6). The U-shaped base 61 is made of the first softer material and extends through the openings 78 in frame 71. Since the first material of the U-shaped base 61 softens at a lower temperature than the second material of frame 71, imprints of upper and lower teeth can be formed in the top and bottom sides 64, 65 of the U-shaped base 61 when the mouthguard 60 is customized.

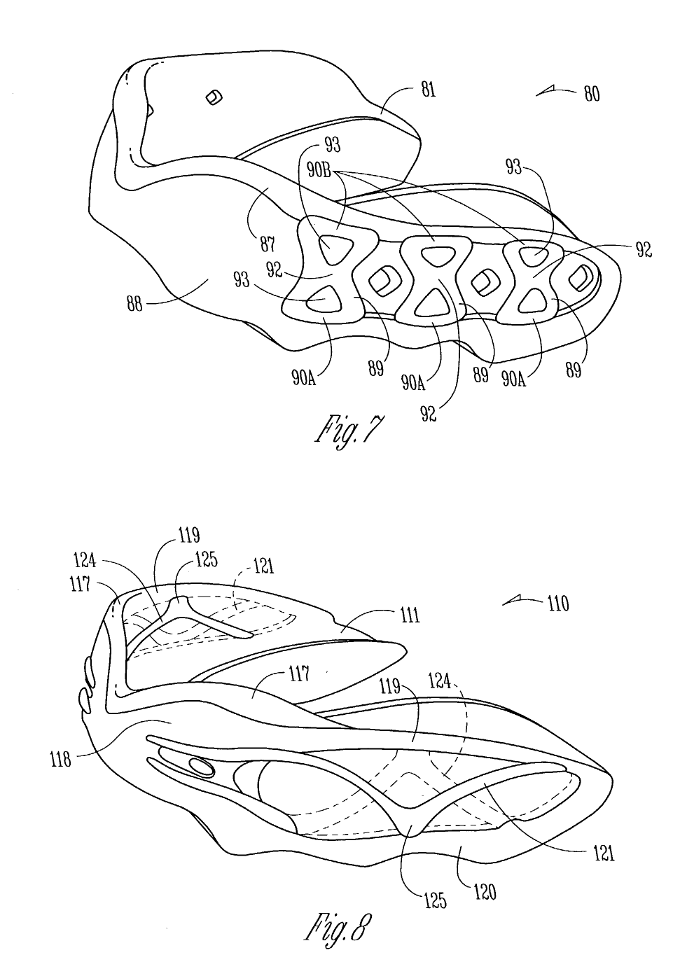

FIG. 7 illustrates a mouthguard 80 that includes a U-shaped base 81 with an anterior portion situated between posterior portions. The U-shaped base 81 is made of a first (e.g., softenable) material and includes a top side and a bottom side. The mouthguard 80 further includes an outer wall 87 extending from the top and/or bottom sides of the U-shaped base 81. In the illustrated example embodiment, a frame 88 made of a second (e.g., nonsoftenable) material forms part of the outer wall 87. The frame 88 includes a plurality of compression columns 89 positioned along the outer wall 87.

As used herein, a compression column, such as compression column 89, includes a support structure formed of two triangular members 90A, 90B connected at a junction 92 which is defined by points of the triangular members 90A, 90B. The triangular members 90A, 90B in the support structure of the compression column 89 maybe further defined by a triangularly-shaped opening 93. It should be noted that mouthguard 80 may include any number of compression columns 89. In addition, the compression columns 89 may be located anywhere, in any orientation, on frame 88.

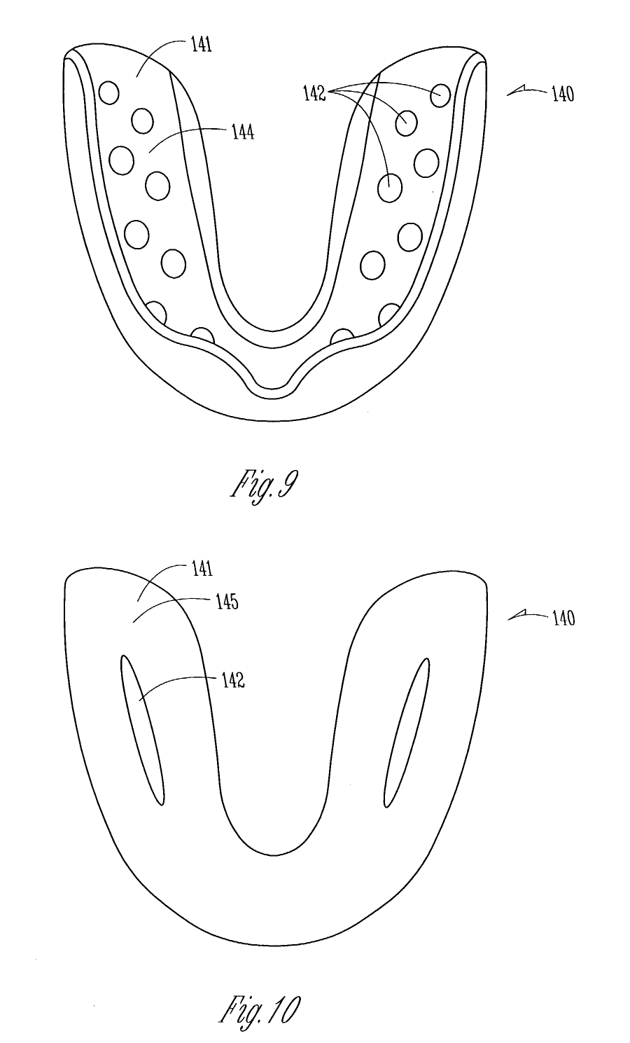

FIG. 8 illustrates a mouthguard 110 that includes a U-shaped base 111 made of a first softenable material. The U-shaped base includes a top side and a bottom side such that an outer wall 117, which is also made of the first softenable material, extends from the top and/or bottom sides of the U-shaped base 111.

In the illustrated example embodiment, a frame 118, which is made of a second material, is secured to the outer wall 117. Frame 118 includes upper portions 119, lower portions 120 and V-shaped supports 121 extending between the upper and lower portions 119, 120 of the frame 118.

The outer wall 117 includes an interior surface and an exterior surface, and in some embodiments the V-shaped support 121 is on the exterior surface of the outer wall 117. The frame 118 may also include an additional V-shaped support 124 on the interior surface of the outer wall 117 that extends between the upper and lower portions 119, 120 of the frame 118. The additional V-shaped support 124 may be inverted relative V-shaped support 121 or oriented in a similar manner. It should be noted that V-shaped support 121 may also be inverted.

Although two pairs of V-shaped supports 121, 123 are shown in the sample embodiment illustrated in FIG. 8, the number, location and orientation of the V-shaped supports may vary in different embodiments. In addition, any of the V-shaped supports may part of a Y-shaped support (not shown) that extends between the upper and lower portions 119, 120 of the frame 118. A Y-shaped support would include an additional support member between a bottom junction 125 of V-shaped support 121 and an upper portion 119 or lower portion 120 of frame 118.

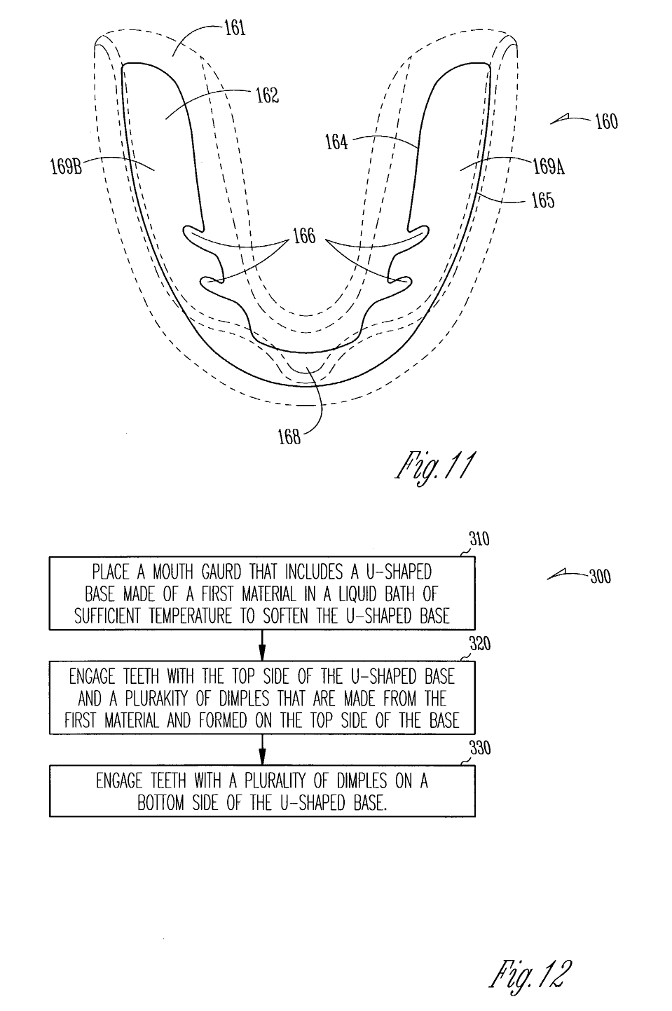

FIGS. 9 and 10 illustrate another mouthguard 140 that includes a plurality of dimples 142 on a top side 144 of a U-shaped base 141. The dimples 142 and the top side 144 of the U-shaped base 141 are formed from the same impressionable material to promote customizing the top side 144 of the U-shaped base 141 without material overflow. As used herein, dimple refers to projections on and/or indentations in the top side 144 of the U-shaped base 141. FIG. 9 shows that the dimples 142 may be arranged in an alternating pattern on the top side 144 of the U-shaped base 141. The dimples 142 may also be arranged along a bottom side 145 of U-shaped base 141 such that the dimples 142 cover portions, or all, of the top and bottom sides 144, 145 of U-shaped base 141. It should be noted that the dimples 142 may take any shape, such as an elliptical shape (see, e.g., FIG. 10 where elliptical dimples 142 are on the bottom side 145 of U-shaped 141).

FIG. 11 illustrates another mouthguard 160 that includes a U-shaped frame 162 supporting a U-shaped base 161. The U-shaped frame 162 and the U-shaped base 161 are made of different materials. The U-shaped frame 162 includes an interior side 164 and an exterior side 165 with grooves 166 in the interior side 164 of the U-shaped frame 162. The grooves 166 facilitate adjustment of the mouthguard 160 to a correct fit as the mouthguard 160 is formed to customize the mouthguard 160.

In the illustrated embodiment, the grooves 166 are between an anterior portion 168 and the posterior portions 169A, 169B of the U-shaped frame 162, although the grooves 166 may be located anywhere on interior side 164 of the U-shaped frame 162. In addition, the number of grooves 166 will vary depending on assorted design considerations.

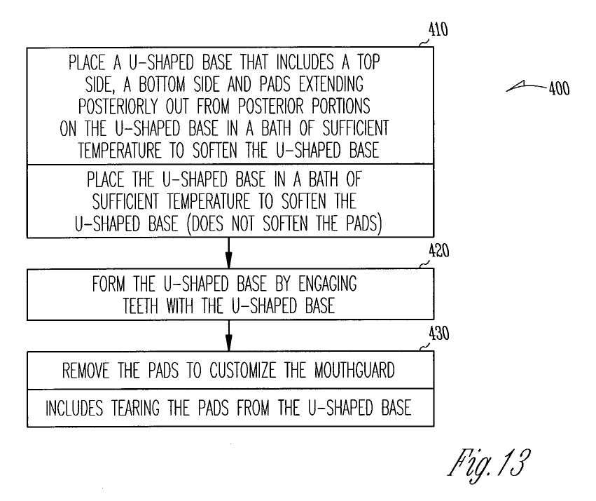

FIG. 12 is a block diagram illustrating an example method of customizing a mouthguard [300]. The method [300] includes placing a mouthguard that includes U-shaped base made of a first material in a liquid bath of sufficient temperature to soften the U-shaped base [310]; and engaging teeth with a top side of the U-shaped base and a plurality of dimples that are made from the first material and formed on the top side of the base [320]. The method [300] may further include [330] engaging teeth with a plurality of dimples on a bottom side of the U-shaped base.

Some example forming operations include submersing the mouthguard into boiling water for 16-60 seconds. This will cause the first material to soften without appreciably softening the second material. Thereafter, the mouthguard is immediately placed onto the teeth in a user's mouth. The user then applies suction to the mouthguard while packing the mouthguard against anterior and posterior teeth. The teeth of the lower jaw index upon the bottom surface of the U-shaped base. The mouthguard conforms around the teeth such that each tooth shape engages the mouthguard. The close fit of the mouthguard reduces the tendency of a wearer to chew on it.

Another block diagram that illustrates an example method of customizing a mouthguard [400] is illustrated in FIG. 13. The method [400] includes placing a U-shaped base that includes a top side, a bottom side and pads extending posteriorly out from posterior portions on the U-shaped base in a bath of sufficient temperature to soften the U-shaped base [410]; forming the U-shaped base by engaging teeth with the U-shaped base [420]; and removing the pads to customize the mouthguard [430].

Removing the pads [430] may include removing the pads from an outer wall that extends from a top side of the U-shaped base. In addition, the pads may be made of a material different from the U-shaped base such that placing the U-shaped base in a bath of sufficient temperature to soften the U-shaped base [410] does not soften the pads.

Some embodiments of the mouthguard may include some form of a liner on the top and/or bottom sides of the U-shaped base and/or inner and outer walls to facilitate forming the mouthguard. The liner may be made of a third material that softens at a temperature lower than the softening temperature of the first material and is softer than the first material when hardened. One example third material is a very soft EVA, such as a material that comprises 100% by weight copolymer of ethylene and vinyl acetate with the copolymer having vinyl acetate 33% by weight.

The present invention may be embodied in other specific forms without departing from the scope of the present invention; therefore, the illustrated embodiments should be considered in all respects as illustrative and not restrictive, reference being made to the appended claims rather than to the foregoing description to indicate the scope of the invention.

We claim:

1. A mouthguard comprising:
a U-shaped base including an anterior portion connected between posterior portions, the base made of a first softenable material and including a top side and a bottom side;
an outer wall extending up from the top side of the base; and
wherein each of the posterior portions on the U-shaped base includes an end portion that is made of a second material that is harder than the first material.

2. The mouthguard of claim 1, further comprising an inner wall extending from the top side of the base to form an upper channel with the top side of the base and the outer wall, and wherein the inner wall and the outer wall include posterior portions with end portions that are made from the second material.

3. The mouthguard of claim 2, wherein the end portions on the posterior portions of the U-shaped base, inner wall and outer wall are integral with one another.

4. The mouthguard of claim 1, wherein the end portions on each posterior portion form at least one-quarter of each posterior portion.

5. A mouthguard comprising:
a U-shaped base including an anterior portion connected between posterior portions, the base made from a first material and including a top side and a bottom side;
an outer wall extending up from the top side of the base; and
a pair of pads extending posteriorly out from the posterior portions on the U-shaped base, one pad extending from one posterior portion and the other pad extending from the other posterior portion.

6. The mouthguard of claim 5, wherein the U-shaped base and the outer wall are made of the first material and the pads are made of a second material.

7. The mouthguard of claim 5, wherein the second material is harder than the first material.

8. The mouthguard of claim 5, wherein each of the pads is thinner than the U-shaped base.

9. The mouthguard of claim 5, wherein the first material is a thermoplastic comprised of copolymers of ethylene and vinyl acetate.

10. The mouthguard of claim 5, wherein each of the pads engages the U-shaped base at shearing areas that have reduced cross-sections compared to the pads.

11. A mouthguard comprising:
a U-shaped base including a top side and a bottom side, the U-shaped made of a first material;
an outer wall extending from the top side of the U-shaped base;
a honeycomb frame made of a second material that is harder than the first material, the honeycomb frame secured to at least one of the U-shaped base and the outer wall.

12. The mouthguard of claim 11, wherein the honeycomb frame is at least partially embedded within at least one of the U-shaped base and the outer wall.

13. The mouthguard of claim 11, wherein the honeycomb frame is embedded entirely within at least one of the U-shaped base and the outer wall.

14. The mouthguard of claim 11, further comprising an inner wall extending from the top side of the U-shaped base such that the honeycomb frame is at least partially embedded within at least one of the U-shaped base, the inner wall and the outer wall.

15. The mouthguard of claim 11, wherein the honeycomb frame includes a pattern of hexagonal openings.

16. The mouthguard of claim 11, wherein the honeycomb frame includes a pattern of openings, the openings in the pattern of openings all being the same size.

17. A mouthguard comprising:
a U-shaped base including a top side and a bottom side;
an outer wall extending from the top side of the U-shaped base; and
a handling tab that includes a body and a pair of extensions projecting from the body, the extensions engaging at least one of the U-shaped base and the outer wall at shearing areas that have reduced cross-sections compared to the extensions.

18. The mouthguard of claim 17, wherein the handling tab is attached to an outside surface on an anterior section of the outer wall.

19. A mouthguard comprising:
a U-shaped base including a top side;
an outer wall extending from the top side of the U-shaped base;
a frame mounted on an outside surface of the outer wall; and
a compression column embedded within the frame, the compression column including a support structure formed of two triangular members connected at a junction which is defined by points of the triangular members.

20. The mouthguard of claim 19, wherein the frame includes posterior portions, and the compression column is in one of the posterior portions of the frame.

21. The mouthguard of claim 19, further comprising at least one additional compression column embedded within the frame to disperse energy throughout the frame.

22. The mouthguard of claim 19, wherein the outer wall also extends from a bottom side of the U-shaped base such that the compression column in the frame extends above and below the U-shaped base.

23. A mouthguard comprising:
a U-shaped base made from a first material, the U-shaped base including a top side;
an outer wall extending from the top side of the U-shaped base, the outer wall made from the first material; and
a frame made of a second material that is harder than the first material, the frame being secured to the outer wall and including an upper portion, a lower portion and a V-shaped support extending between the upper portion and the lower portion of the frame.

24. The mouthguard of claim 23, wherein the V-shaped support is part of a Y-shaped support extending between the upper and lower portions of the frame.

25. The mouthguard of claim 23, wherein the outer wall includes an interior surface and an exterior surface and the V-shaped support is on the exterior surface of the outer wall.

26. The mouthguard of claim 25, wherein the frame includes an additional V-shaped support on the interior surface of the outer wall, the additional V-shaped support extending between the upper and lower portions of the frame.

27. The mouthguard of claim 26, wherein the additional V-shaped support is inverted relative to the U-shaped support on the exterior surface.

28. The mouthguard of claim 23, wherein the V-shaped support is inverted.

29. A mouthguard comprising:
a U-shaped base including a top side and a bottom side, the U-shaped base made from a first material; and
a plurality of dimples made from the first material, the dimples formed on the top side of the U-shaped base to promote customizing the top side of the U-shaped base without material overflow during a fitting operation.

30. The mouthguard of claim 29, wherein the plurality of dimples are arranged in an alternating pattern on the top side of the U-shaped base.

31. The mouthguard of claim 29, wherein the plurality of dimples are also on the bottom side of the U-shaped base.

32. The mouthguard of claim 29, wherein each of the plurality of dimples are elliptically-shaped.

33. A mouthguard comprising:
a U-shaped base made from a first material, the U-shaped base including a top side;
an outer wall extending from the top side of the U-shaped base; and
a U-shaped frame supporting the U-shaped base, the U-shaped frame being made of a second material and including an interior side and an exterior side, the U-shaped frame including at least one groove in the interior side of the U-shaped frame to facilitate adjusting the U-shaped frame as the mouthguard is customized.

34. The mouthguard of claim 33, wherein the U-shaped frame includes an anterior portion between posterior portions such that the at least one groove is between the anterior portion and one of the posterior portions.

35. The mouthguard of claim 34, wherein the U-shaped frame includes a first pair of grooves between the anterior portion and one posterior portion and a second pair of grooves between the anterior portion and the other posterior portion.

36. A method of customizing a mouthguard comprising:
placing a mouthguard that includes U-shaped base made of a first material in a liquid bath of sufficient temperature to soften the U-shaped base; and
engaging teeth with a top side of the U-shaped base and a plurality of dimples that are made from the first material and formed on the top side of the base.

37. The method of claim 36, further comprising engaging teeth with a plurality of dimples on a bottom side of the U-shaped base.

38. A method of customizing a mouthguard comprising:
placing a U-shaped base that includes an anterior portion, a posterior portion and pads extending posteriorly out from the posterior portions in a bath of sufficient temperature to soften the U-shaped base;
forming the U-shaped base by engaging teeth with the U-shaped base; and
removing the pads to customize the mouthguard.

39. The method of claim 38, wherein removing the pads includes tearing the pads from the U-shaped base.

40. The method of claim 38, wherein the pads and the U-shaped base are made of different materials such that placing the U-shaped base in a bath of sufficient temperature to soften the U-shaped base does not soften the pads.
